(19) United States
(12) Patent Application Publication
(10) Pub. No.: US 2011/0184913 A1
(43) Pub. Date: Jul. 28, 2011

(54) DISTRIBUTED DATA BACKUP

(75) Inventors: Charles C. Hayden, Issaquah, WA (US); RaviKant Cherukuri, Snoqualmie, WA (US); Fei Dai, Seattle, WA (US); George Joy, Kirkland, WA (US)

(73) Assignee: Microsoft Corporation, Redmond, WA (US)

(21) Appl. No.: 12/695,296

(22) Filed: Jan. 28, 2010

(51) Int. Cl. G06F 17/30; G06F 15/16

(52) U.S. Cl. 707/652; 707/E17.007; 707/E17.032; 709/219

(57) ABSTRACT

One or more techniques and/or systems are disclosed herein for backing up in-memory working store data. A first server in a plurality of connected servers detects a data change for a key-value pair the distributed in-memory working store. The first server determines a backup location for storing a copy of the key-value pair, which is comprised on a backup location server from the plurality of connected servers, by using a key from the key-value pair to identify the backup location server, and determine if the backup location server is available to store the backup copy. The first server sends the backup copy to the backup location server without prior permission from the backup location server and without subsequent feedback from the backup location server concerning the sending of the backup copy.

### BACKGROUND

Data storage requirements continue to scale upward significantly. Often, large server farms are used by enterprises and online entities to store, manage and distribute data. As an example, online environments can comprise distributed applications that are accessed and used by millions of online users. Further, as cloud-based application grow larger, a need for cached data (e.g., for faster retrieval) grows larger. Often, data for these distributed applications is chopped up and stored in several locations that can accommodate the amount and scalability of the data. In order to accommodate the distributed data, distributed database systems are utilized that can manage data as a unit, even though the data may be disparately distributed over several locations.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Problems can arise if a server in a distributed database fails (or is brought offline), as the data store thereon may be lost. Often, for important data that is difficult to recreate (e.g., permanent data such as a user name and password) data loss not acceptable. For this type of data, redundant database storage is usually created, whereby backup copies are kept on another server.

Other data, such as transient data, may be less important, as it can be recreated, for example, by users. Examples of such data can include a login session id, location, and data from a remote location that is cached locally. Even though this type of transient data may be able to be recreated, data loss can still impact user experience, for example. For this reason, currently, some systems provide mirrored data on pairs of servers. However, this can increase storage costs and resources.

Other systems utilize a database (e.g., SQL) that interacts with an application (e.g., and API), and divides conversations (e.g., data transfer between server and client) into transactions. Here, at the end of each transaction, the data written to one server is written to an alternate server, thereby substantially preserving integrity of data. However, this type of transaction iteration is very complex, which can lead to distributed transaction management problems, and is computationally expensive.

One or more techniques and/or systems are disclosed that provide for backup and restoration of this type of transient data, such as information that is typically held in in-memory caches of a distributed working store comprising a plurality of servers. This distributed in-memory working store can provide backup for itself, for example, making a middle layer cache more efficient and reliable. When parts of data in the distributed working store change, for example, the changes can be reflected across the backup system by copying to the change to another location.

In one embodiment for backing up in-memory working store data, a server in a plurality of connected servers detects a data change for a key-value pair in its portion of the working store. The server determines a backup location for storing a copy of the key-value pair, which is a backup location server from the plurality of connected servers. To determine the backup location, the server uses a key from the key-value pair to identify the backup location server, and checks to see if that backup location server is available to store the backup copy. The server then sends the backup copy to the backup location server without prior permission from the backup location server and without subsequent feedback from the backup location server concerning the sending of the backup copy.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary environment in which one or more methods and/or systems, described herein, may be utilized.

FIG. 2 is a flow diagram illustrating an exemplary method for backing up in-memory working store data.

FIG. 3 is an illustrative example environment where one or more techniques and/or systems, described herein, may be implemented.

FIG. 4 is a flow diagram illustrating one embodiment of an implementation of one or more of the techniques described herein.

FIG. 5 is a flow diagram illustrating one embodiment whereby data stored in a working store can be managed when a change in server status occurs.

FIG. 6 is a flow diagram illustrating one embodiment whereby data stored in a backup store can be managed when a change in server status occurs.

FIG. 7 is a flow diagram illustrating one embodiment of implementing one or more of the techniques described herein for a server's planned failure.

FIG. 8 is a component diagram of an exemplary system backing up in-memory working store data.

FIG. 9 is a component diagram illustrating one embodiment of an implementation of one or more of the systems described herein.

FIG. 10 is a component diagram illustrating one embodiment of an implementation of one or more of the systems described herein.

FIG. 11 is an illustration of an exemplary computer-readable medium comprising processor-executable instructions configured to embody one or more of the provisions set forth herein.

FIG. 12 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

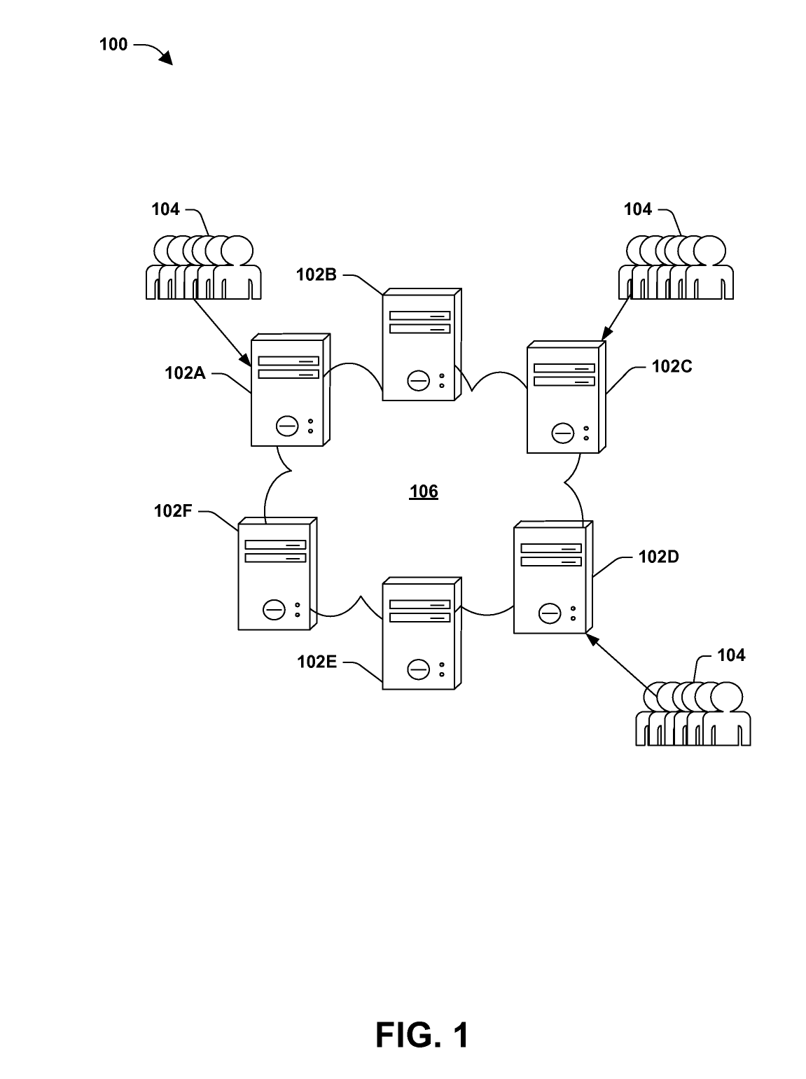

A method may be devised that provides for distributed in-memory storage in a plurality of connected servers, such as in a server farm, where data can be backed-up and restored to alternate locations to mitigate data loss in a server down event, for example. As an example, FIG. 1 illustrates an exemplary environment 100 in which one or more of the methods and/or systems, described herein, may be utilized. A plurality of servers 102A-F may be deployed to service a plurality of users 104. In this exemplary environment 100, the servers 102 can be connected over a type of transport layer 106, such as a network connection that links the servers 102, and utilized for clients to connect to the system (e.g., 102A, 102C, 102D), and/or for a distributed cache for the system (e.g., 102B, 102E, 102F). It will be appreciated that the exemplary arrangement 100 is merely illustrative, and may comprise various other arrangements, and/or number of servers/users/caches, etc.

In one embodiment, the servers 102 may be deployed in a server farm that services an online environment, whereby data generated by users 104 is stored in the servers 102. In this embodiment, for example, a user's login properties, such as session information, IP address, etc., can comprise data that is typically considered transient (e.g., not permanently stored). Often, this type of data is stored in a server's cache location (e.g., transient storage, such as volatile memory), for example, in contrast to the server's database-type storage (e.g., non-volatile memory, such as disk-type storage). In this example, the cache-type memory is usually stored in the volatile memory for faster retrieval. While this type of data, if lost (e.g., by server failure), can be recreated (e.g., not permanent-type data), for example, as cloud-based applications grow, a need for in-memory cache increase and potential for data loss increases.

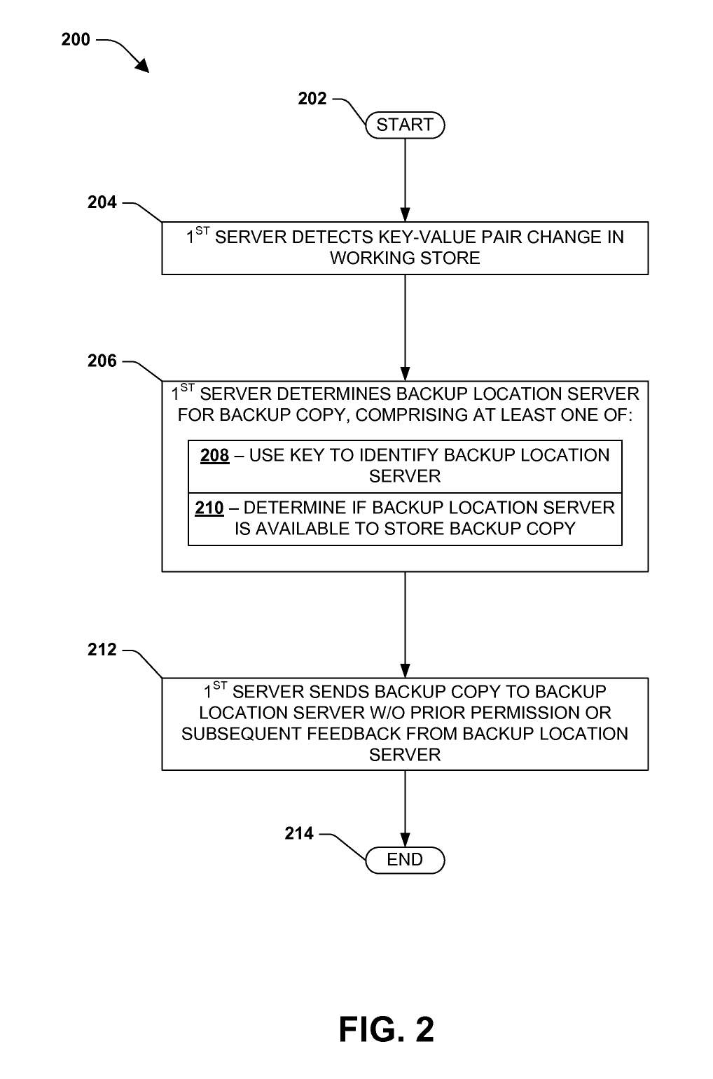

FIG. 2 is a flow diagram illustrating an exemplary method 200 for backing up in-memory working store data, for example, where cached data can be retrieved in a server loss event. The exemplary method 200 begins at 202, and involves a first server, which is connected to a plurality, detecting a change in a key-value pair that represents data in a distributed in-memory working store, at 204. For example, a server's in-memory working store may comprise cached information, such as data stored on another physical location (e.g., another server's disk storage) that is regularly accessed by a client connected to the server and can be retrieved from the other storage, and/or transient data, such as chat session log information (e.g., connection information, etc.) that can be recreated by users.

In one embodiment, data in the first server's portion of the in-memory working storage can be changed, for example, when the cached information is updated, such as when the client changes a value of the information stored in the cache. Further, in another example, new data may be added to the in-memory working store, such as when a new chat session is initiated for a user. In this embodiment, respective data is stored as a key-value pair, where the value represents the data stored, and the key can be a unique identification that is associated with a particular user on a client, for example. In this way, in one embodiment, data generated and maintained for a user, for example, can be kept together in a same location. Keeping a user's data together may allow for faster retrieval and identification, along with easier data management for backing up the data.

Therefore, in one embodiment, detecting a key-value pair change may comprise an update to the key-value pair, a creation of a key-value pair, or removal/deletion of a key-value pair from the working store. For example, if a user of a client connected to the first server changes the value of the pair, such as by updating an address, a change may be detected. Further, if a new key-value pair is created, such as by a new user logging into the system and adding their IP address as a location, a change may also be detected.

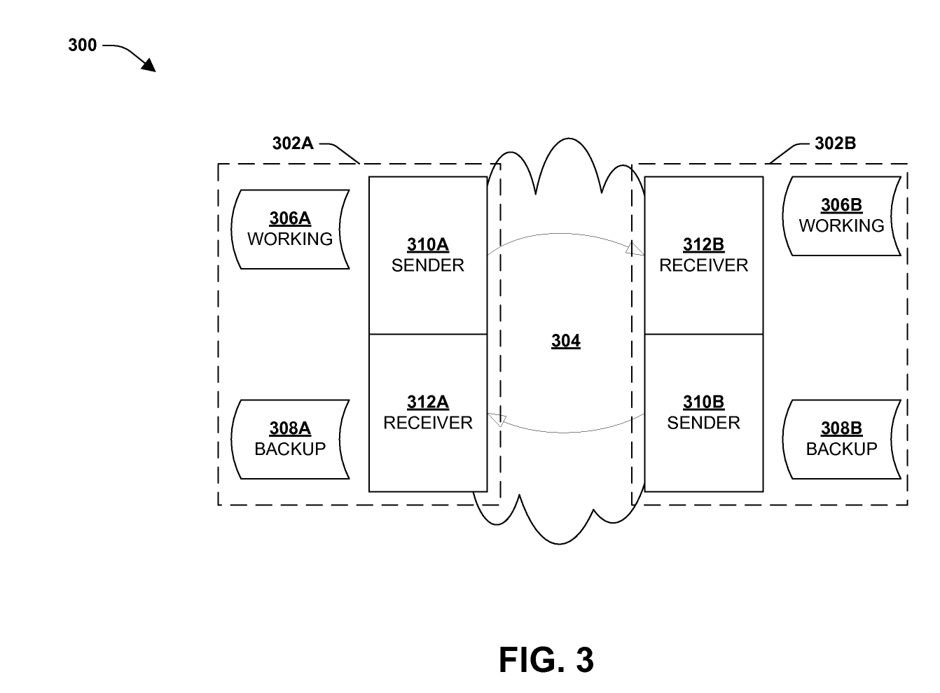

At 206, in the exemplary method 200, the first server determines a backup location for storing a backup copy of the key-value pair, where the backup location is another server from the plurality of connected servers, comprising a backup store located on a backup location server. FIG. 3 is an illustrative example environment 300 where one or more of the techniques and/or systems, described herein, may be implemented. Servers 302A and 302B are connected over a transport layer 304 (e.g., the plurality of servers 102A-F connected over 106 of FIG. 1). The respective servers 302 comprise working stores 306A-B, and backup stores 308A-B. In one embodiment, a first server (e.g., 302A) may determine that the backup store (e.g., 308B) of a second server (e.g., 302A) may be the backup location for storing the backup copy of the key value pair from the first server's working store (e.g., 306A).

Determining the backup location for the backup copy comprises using a key from the key-value pair to identify the backup location server, at 208, and determining if the backup location server is an appropriate candidate (e.g., in an appropriate status) to store the backup copy, at 210. As an example, a new unique key can be created and used to aggregate associated data together, such as when a new user session is created (e.g., all data associated with the user session can have the same key). In one embodiment, the key can be used to identify a particular server on which respective chunks of an aggregated set of data is stored, for example, such that the key uniquely identifies the aggregated set of data.

In one aspect, a key can be associated to a working store of a particular server in a variety of ways. In one embodiment, a hash function may be chosen in which a key can be input and a server number may be output. For example, the plurality of connected servers may be numbered from 1 . . . n, and the unique key for the key-value pair can be input to the hash function. The output of the hash function may be one of the servers from 1 . . . n. In another embodiment, the key may be associated with a particular server in a lookup table, such as an extensible markup language (XML) table. In this embodiment, for example, the key from the value-key pair may be looked up in the table and the associated server chosen as the backup location.

In one aspect, the backup location server identified by the key should be in a condition that allows the backup copy to be backed up. In one embodiment, respective states of the connected servers are known to each other, for example, by a master status tracker that periodically determines the servers' status and sends out a status report. Examples of server status comprise a server being up (e.g., operational), down (e.g., non-operational), coming up (e.g., transitioning from a down to an up condition), and coming down (e.g., transitioning from an up to a down condition).

In this aspect, in one embodiment, a server may be available to another server when they are in an up and coming up condition. For example, when a server enters a coming up state data can be moved to it, and when the server enters a coming down state data can be moved from it to another server. In another embodiment, where one or more clients are connected to the respective servers, for example, an available server may be in an up and coming down condition. In this embodiment, when the server is coming up client traffic is not moved to it, and when the server is coming down client traffic is not moved from the server.

Therefore, in one embodiment, the key can identify a backup server, for example, by lookup or hash function. If the backup server identified is in a condition (state) that allows data to be moved, such as from another server when the backup server is coming up, the data can be moved. However, if the server is in a condition that does not allow the backup copy to be moved to it, an alternate backup server can be identified as a backup location, and it can be determined if the alternate server is in an appropriate condition. This cycle of potential backup server identification and state determination, for example, can continue until an appropriate backup location server is identified.

In one embodiment, the first server determining a backup location can comprise determining that a primary location for the key-value pair is the first server. For example, if the first server is in a coming down state, it may no longer be in a condition that allows it to be a primary storage location (primary location) for working store data. In this example, the primary location for the data in the first server's working store may be changed to another server in a condition that allows it to act as a primary location. However, as described above, a client may still be sending data to the working store of the first server, even in the coming down state.

In this embodiment, it should be determined that the first server is still the primary location for the key-value pair that has changed, for example. As described above, determining if the first server is the primary location comprises using the key from the key-value pair to determine the primary location, and determining if the primary location server is available. Further, as described above, once the first server is determined to be the primary location, the backup server location can be identified using the key and determining if it is available (e.g., in an appropriate state).

At 212 of the exemplary method 200, in FIG. 2, the first server sends the backup copy to the backup location server without prior permission from the backup location server and without subsequent feedback from the backup location server concerning the sending of the backup copy. Having sent the backup copy to the backup location server, the exemplary method 200 ends at 214.

It will be appreciated, that while one or more of the embodiments described herein include “the first server sending the backup copy to the backup location server . . . without subsequent feedback from the backup location server concerning the sending of the backup copy,” this description is merely illustrative with regard to feedback about the sent backup copy. However, in some embodiments, if feedback is available, for example, concerning where metadata may be updated to incorporate updated locations of stored data, this feedback may be utilized by one or more of the techniques and/or systems, described herein. For example, the first server may or may not receive subsequent feedback concerning updated metadata. That is, such feedback may or may not be incorporated into one or more of the techniques and/or systems described herein.

As an illustrative example, in the exemplary environment 300 of FIG. 3, server 302A (e.g., the first server) can retrieve the a copy of the changed key-value pair from its working store 306A, and, utilizing a sender 310A, sends a backup copy of the key-value pair across the transport layer 304 to server 302B (e.g., the backup location server). In this example, a receiver 3128 in the server 302B receives the backup copy of the key-value pair and sends it to the backup store 308B.

In this embodiment, the sending of the backup copy of the key-value pair is performed merely at the discretion of the sending server. That is, for example, no other interaction (other than the sending to) with the receiving server need be involved for the backing up of key-value pairs from the working store. As another example, the sending server (e.g., the first server) may know a status of the receiving server (e.g., the backup location server), prior to sending the backup copy, based on a server status report, such as received from a master status tracker of the plurality of servers. However, in this example, at the time of the sending the status of the receiving server may have changed unbeknownst to the sending server (e.g., changed from up to coming down).

In this embodiment, regardless of the current state of the receiving server, for example, the sending server sends the backup copy to the receiving server based on the most recent status report received by the sending server. The sending server merely follows directions to send out backup copies of changed key-value pairs, for example, to those one or more backup location servers without regard to what happens once sent. Further, in this embodiment, the receiving component does not acknowledge the receipt of the backup copy, nor does it respond with a status to the sending server. The receiving component, for example, will merely store the backup copy of the key-value pair in its backup store. In this way, for example, a system utilizing these techniques may mitigate “jamming” due to communications trouble, and may operate at a higher performance level due to less back and forth communications.

In one embodiment, while determining a backup location, the first server may determine that the primary location for the key-value pair is not the first server. As described above, for example, the first server may be in a coming down state, which no longer allows it to be a primary location for working store data. In this embodiment, the first server can send a copy of the key-value pair to the primary location, which is on the identified primary location server (e.g., based on the key and status of the primary location server). In this way, for example, the primary location server receives the key-value pair, stores it in its working store, then can send a backup copy to a backup location server, as described above.

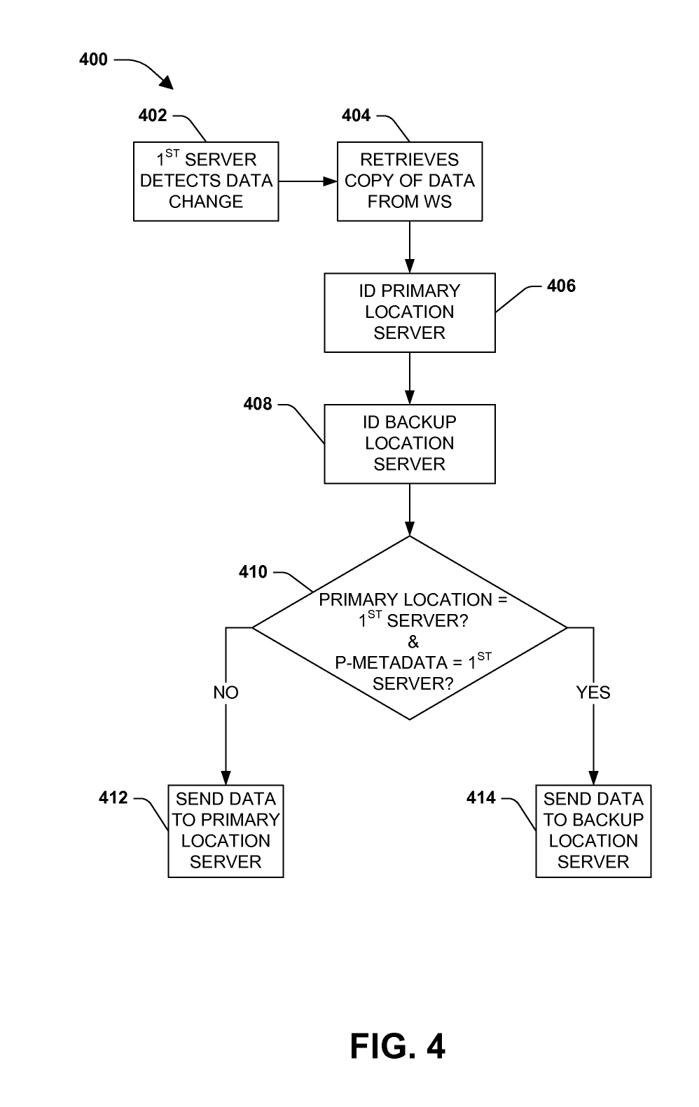

FIG. 4 is a flow diagram illustrating one embodiment 400 of an implementation of one or more of the techniques described herein. At 402, the first server detects a change in data stored in its working store, which may comprise, for example, creation of a new key-value pair, or changing the value of the key-value pair. At 402, a copy of the changed data is retrieved from the working store, which can be used as a backup copy or as a primary copy on another server.

At 406, the primary location server is identified, as described above, using the key from the key-value pair and checking that a status of the identified primary location server is appropriate for storing the key value pair. At 408, a backup location server is identified, as described above, again using the key and checking a status of the identified backup location server.

At 410, a decision is made concerning where the copy of the key-value pair is to be sent. In one embodiment, respective key-value pairs comprise metadata, which may be attached to the key-value pair when they are created, for example. In this embodiment, the metadata can comprise primary location metadata that identifies the primary location server where the key-value pair is stored in the working store. Further, the metadata can comprise backup location metadata that identifies the backup location server where a backup copy of the key-value pair is stored in the backup store. Additionally, the metadata can comprise version number metadata that identifies a version of the value in the key-value pair, where the version number is incremented for respective value changes in the key-value pair.

At 410, if the primary location server for the key-value pair, identified at 406, is the first server; and the primary location metadata attached to the key-value pair identifies the first server (YES), the first server sends the copy of the key-value pair to the identified backup location server, as a backup copy, at 414. However, at 410, if the primary location server for the key-value pair, identified at 406, is not the first server; and/or the primary location metadata attached to the key-value pair does not identify the first server (NO), the first server sends the copy of the key-value pair to the identified primary location server, at 412.

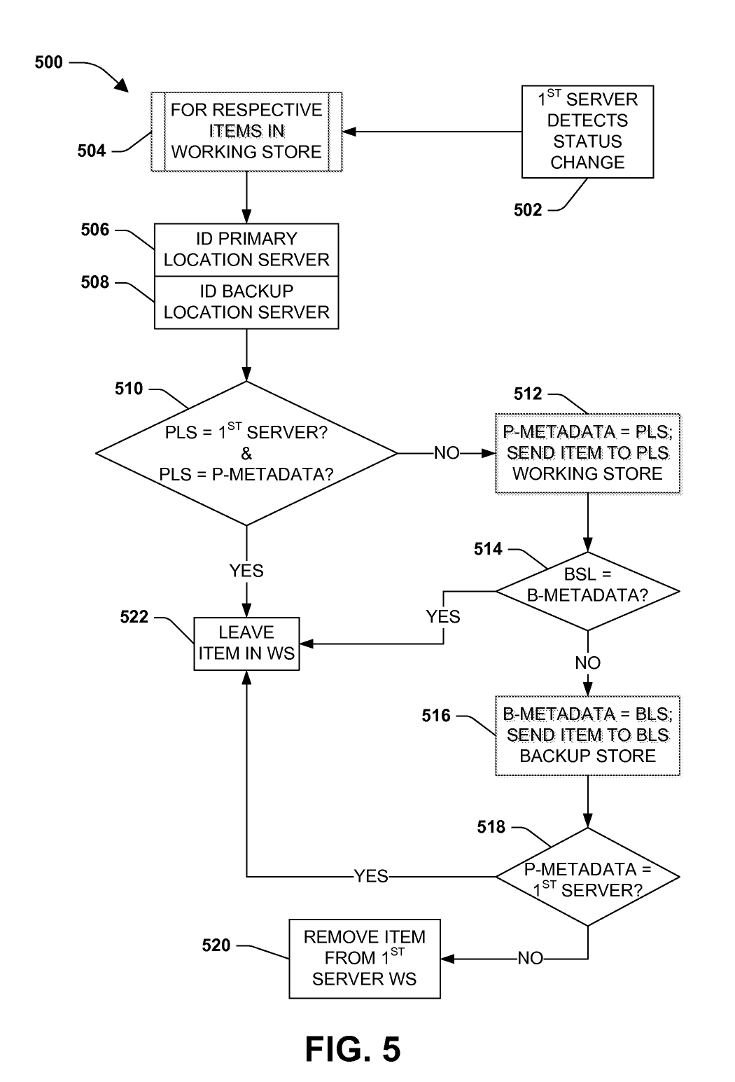

In one aspect, a server in the plurality of servers may change from one state to another, such as “coming up” to “up.” In this aspect, a change of state may initiate actions that facilitate management of the key-value pairs in primary storage locations, and copies of the key-value pairs in backup storage locations. FIG. 5 is a flow diagram illustrating one embodiment 500 whereby data stored in a working store (e.g., primary location) can be managed when a change in server status occurs. At 502 the first server detecting that a status change has occurred in a server from the plurality of servers.

As described above, in one embodiment, a server in the plurality of connected servers may be in one of four states (conditions). “Up,” where the server is normally operationally, for example; “down,” where the server is unable to operate normally; “coming up,” where the server is transitioning to an “up” state; and “coming down,” where the server is transitioning to a “down” state. In this embodiment, the first server may identify that a second server, for example, from an up state to a coming down state.

In one embodiment, as described above, a server status tracker can determine a status of the respective servers, for example, by monitoring the servers, or by sending status requests to the servers. In this embodiment, the status tracker may periodically compile a status report for the servers and send the report to the respective connected server. In this way, for example, the first server may identify a status change of a second server from consecutive reports, such as a first report identifying an “up” state for the second server and a second report identifying a “coming down” state for the second server. As another example, the status report may identify a state change for a server based on the monitoring results, and the status report can include any identified status changes.

At 504 in the exemplary method 500, the first server determines what to do with the respective items (e.g., key-value pairs) stored in its working store, based on the status change. For example, when a server status changes, an assignment of a primary and backup location can potentially change for respective key-value pairs in a server's working store. That is, if a second server changes from an “up” to a “coming down” state, it may no longer act as a backup location.

At 506, a primary location server is identified for a key-value pair first server's working store, based on the key from the key-value pair and the status of a primary location server identified by the key. At 508, a backup location server is identified for a key-value pair first server's working store, again based on the key from the key-value pair and the status of a backup location server identified by the key.

At 510, a decision is made to determine whether the key-value pair is sent to another server. If the identified primary location server is the first server, and the primary location server is identified by the primary location metadata attached to the key-value pair (YES), the key-value pair (item) is left is the working storage of the first server, at 522. However, if the identified primary location server is not the first server, and/or the primary location server is not identified by the primary location metadata attached to the key-value pair (NO), the primary location metadata is updated to the identified primary location server, at 512; and the key-value pair is sent to the primary location server, where is can be stored in its working store.

In one example, the primary location server may not be the first server when the primary location server identified is in a “coming up” state. In this example, the server that is coming up will take ownership of the data, where it may have been the primary location prior to going down, and the first server merely took temporary ownership of the data during this time. Further, for example, the primary location metadata may not identify the first server when the data has already been moved, but the state change (or another state change) has superceded where the data has to be moved again (e.g., the server that the data was moved to is not in a condition to act as a primary location).

At 514, a decision is made to determine what to do with a backup for the key-value pair. If the backup location server (identified at 508) is identified by the backup location metadata attached to the key-value pair (YES), the item is left in the working of the first server (e.g., no backup copy is sent out), at 522. However, if the backup location server is not identified by the backup location metadata (NO), at 516, the backup location metadata is updated to the identified backup location server (from 508); and the key-value pair is sent to the identified backup location server.

It will be appreciated that respective sending of items (e.g., data, key-value pairs), described herein, is performed merely at the discretion of the sender, as described above, whether they are copies of primary items or backup items, for example. That is, the sender of the item does so without prior permission from the receiver, and without subsequent response from the receiver concerning the sending of the item.

It will be appreciated, that while one or more of the embodiments described herein include “the sender of the item does so without . . . subsequent response from the receiver concerning the sending of the item,” this description is merely limited to feedback about the sent backup copy. However, in some embodiments, if feedback is available, for example, as described above (e.g., with regard to metadata), this feedback may be utilized by one or more of the techniques and/or systems described herein.

At 518, if the primary location metadata attached to the item identified the first server (e.g., the first server is the primary location for the key-value pair), the item is left in the working storage of the first server. However, if the primary location metadata does not identify the first server (e.g., it identifies a second server in the plurality of connected servers), the item can be removed from the working storage of the first server, at 520. Further, in one embodiment, in order for the item to be removed both the state of the first server should be in an “up” condition and the state of the primary location server identified by the metadata should be in a condition to act as a primary location for the key-value pair.

For example, the item can be scheduled for later removal at an appropriate time, such as when the first server is in a state that allows for removal. In this way, for example, if the item's primary location is on a second server, the second server will have made a backup copy and sent it to a third server's backup store. Therefore, in this example, a duplicate of a key-value pair can be removed to save storage space in the distributed in-memory working store.

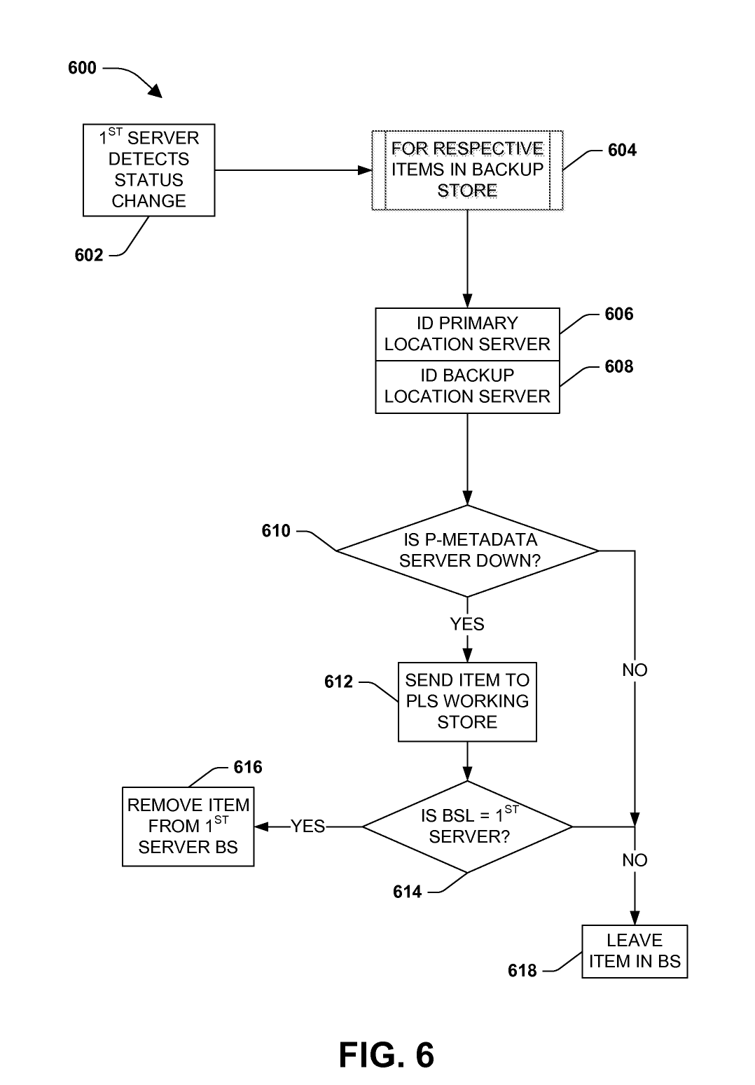

FIG. 6 is a flow diagram illustrating one embodiment 600 whereby data stored in a backup store (e.g., backup location) can be managed when a change in server status occurs. When the first server detects a status change, at 602, it can determine what to do with the respective items (e.g., key-value pairs) stored in its backup store, based on the status change. In a similar manner as described above with items in the working store, the primary and backup locations servers are identified for a key-value pair, at 506 and 508 respectively.

At 610, a decision is made about what to do with a copy of the key-value pair. If the server identified by the primary location metadata attached to the key-value pair is not in a down status, the key-value pair is left in the first server's backup store (e.g., a copy is not sent out), at 618. However, if the server identified by the primary location metadata is in a down status, a copy of the item is sent to the primary location server identified at 506, at 612. In this way, for example, the item that was backed-up to the first server's backup store can be iterated as a primary copy of the key-value pair to a new primary location (e.g., the identified primary location server). Therefore, in this example, both a primary and backup location are maintained when the item's previous primary location is lost (e.g., server status changed to down).

At 614, if the backup server location identified at 608 is the first server, the item is left in the first server's backup store, at 618. That is, if the first server is still the identified backup location it will retain the backup copy for the item after the detected status change, for example. However, if the first server is not the backup location server, the item can be removed from the first server's backup store, at 616. That is, if the backup location server has be updated for the item, such as when another server is coming up after being down, the item can be removed to avoid duplication and improve storage availability, for example.

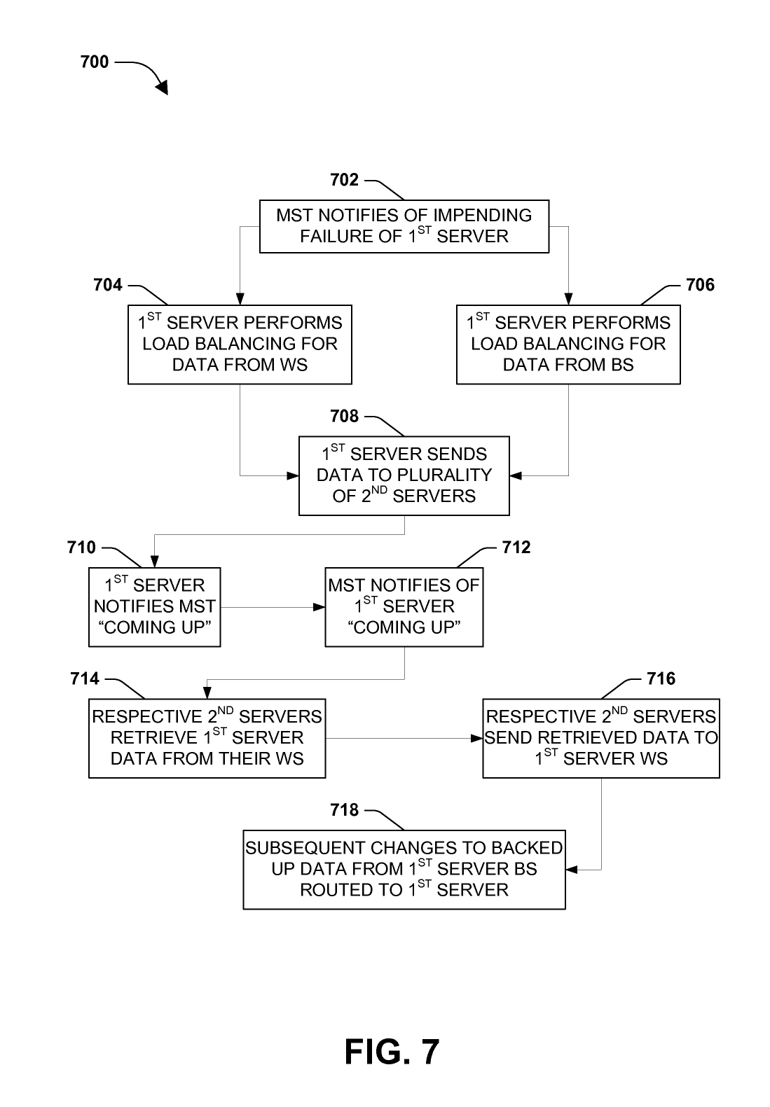

In one aspect, a server may have prior knowledge that it may become unoperational, such as going from up to coming down to down. As an example, the server may be scheduled for maintenance or replacement. In this aspect, in one embodiment, the server may prepare for becoming unoperational by sending copies of its primary location data and backup location data to other servers in the plurality of servers of the distributed in-memory working store. FIG. 7 is a flow diagram illustrating one embodiment 700 of implementing one or more of the techniques described herein for a server's planned failure.

At 702, a master status tracker notifies the plurality of servers of an impending failure of a first server, such as by using a server status report, or an individual notification to respective servers. In one embodiment, the notice to the other servers may trigger them to perform updates, and/or sending of data, from their respective working and backup store, as described above.

At 704, in the exemplary embodiment 700, the first server performs a load balancing determination for the respective data items (e.g., key-value pairs) that are stored in its working store. Further, at 706, the first server performs a load balancing determination for the items in its backup store. For example, because the first server has an impending failure, a new primary location is identified for the respective items in the working store, and a new backup location for the items in the backup store.

Additionally, in this example, a load balancing determination can be used to select a primary location server based on a status of the plurality of servers, so that the items from the first server's working store are distributed relatively evenly across the distributed working store. It will be appreciated that the techniques described herein are not limited to any particular embodiment of load balancing, and that those skilled in the art may devise load balancing techniques that can be used.

At 708, the first server sends the respective items from its working store to a plurality of second server working stores, and sends respective items from its backup store to a plurality of second server backup stores. It will be appreciated that the second server working stores and second server backup stores may or may not be on a same server. The term second server is merely used to illustrate that the items are being sent to different servers of the connected plurality of servers. Further, as described above, the items are sent without prior permission or subsequent response from the second servers.

At 710, when the first server is returning to operation, it notifies the master status tracker that it is coming up. The master status tracker notifies the plurality of servers that the first server is “coming up,” such as by a status report or separate notice, at 712. In this way, the respective second servers can perform an evaluation of the items stored in their working and backup stores, such as described in FIGS. 5 and 6, and send the items to the first server's working store, at 716.

At 718, when the first server receives the items from the respective second servers, it can identify backup location servers for copies of backups, such as described in FIG. 4. Further, any subsequent changes to the backed up data from the first server's backup storage before it went down, can be routed back to the first server's backup store, as it is once again the preferred backup location for this data, for example.

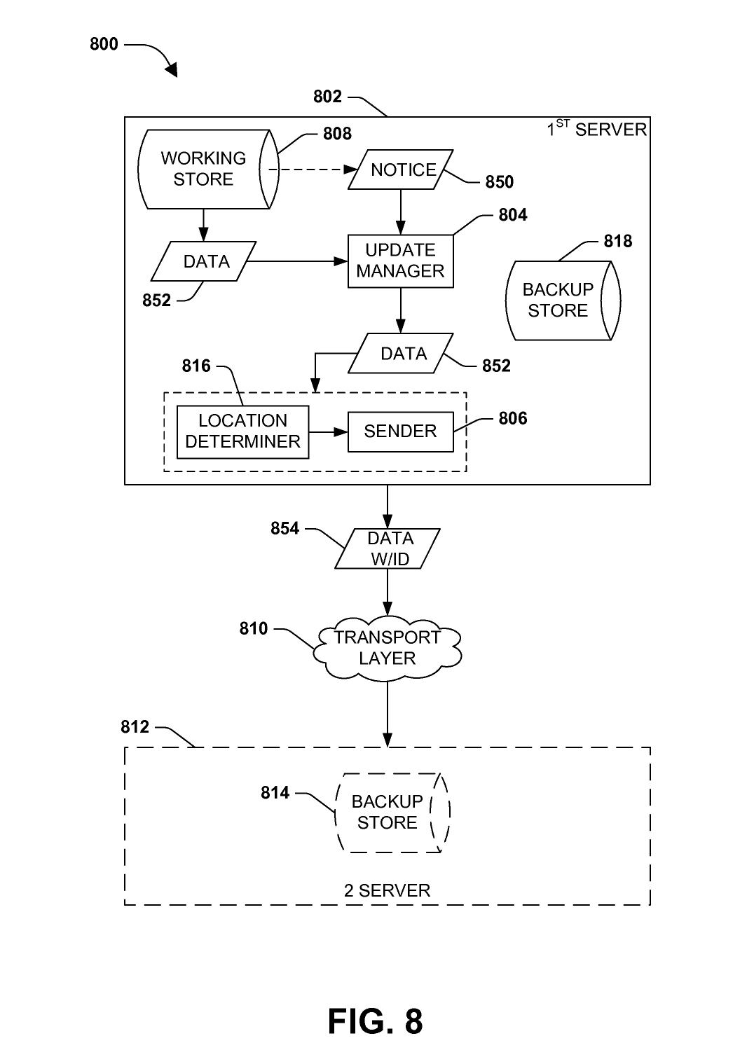

A system may be devised for storing and backing up in-memory data from a distributed working store. FIG. 8 is a component diagram of an exemplary system 800 backing up in-memory working store data. A plurality of servers 802 and 812 is operably coupled over a transport layer 810. The servers respectively comprise an in-memory working store 808 that stores a working store key-value pair for data stored in the working store 808.

A first server 802 (e.g., and the respective other servers 812 may) comprises a backup store 818 (e.g., and 814) that stores a backup store key-value pair, which is a backup copy of the working store key-value pair from a primary location server. That is, for example, the working store (e.g., 808) of a server (e.g., 802) is a primary location for a key-value pair, and the backup store (e.g., 814) comprises backup copies of the key-value pairs from one or more primary locations.

In the exemplary system 800, the first server 802 further comprises an update manager 804 that receives a notification 850 that data 852 has changed for a key-value pair in the working store. For example, when a key-value pair is added to the working store 808, or a value from the key-value pair is changed, or even when a key-value pair is deleted, the update manager 804 is notified. A location determination component 816 is operably coupled with the update manager 804, and it determines a backup location for storing a backup copy 852 of the working store key-value pair.

The location determination component 816 determines the backup location for the backup copy by identifying a backup location server 812 from the plurality of servers that comprises the backup location 814 by using the key from the working store key-value pair. Further, the location determination component 816 determines that the identified backup location server 812 is in a condition to act as the backup location (e.g., in an up or coming up state).

In one embodiment, the determination component 816 can comprise a backup location determination component that determines a backup location server by applying a function to the key from a key-value pair, such as a hash function. Further, the determination component 816 can comprise a primary location determination component that determines a primary location server by applying a function to the key from a key-value pair. In this way, for example, when a unique key is input to the function, a same server identification number can be output for the unique key. Therefore, in this example, key-value pairs having a same key will be stored on a same server.

Additionally, in this embodiment, the determination component 816 can comprise a server status identification component, which can determine if the status of the server identified by the backup location determination component meets a desired status to act as a backup location server (e.g., up or coming up). The server status identification component can also determine if the status of the server identified by the primary location determination component meets a desired status to act as a primary location server. After determining a status, the server status identification component notify the server status identification component to determine a second backup or primary location if the status does not meet the desired status.

Additionally, the first server 802 comprises a sender component 806 that is operably coupled with the location determination component 816. The sender component 806 sends the backup copy 854, with the identified location, to the transport layer 810, so that it can be sent to the backup location server 812. The sending is performed without prior permission from the backup location server 812 and without subsequent feedback from the backup location server 812 concerning the sending of the backup copy 854.

In the exemplary system 800, the transport layer 810 is operably coupled to the respective servers 802 and 812, and it to forwards the backup copy 854 from the first server 802 to the backup location server 812. In one embodiment, the transport layer couples each of the respective servers from the plurality of servers, so that data can be sent between the respective servers.

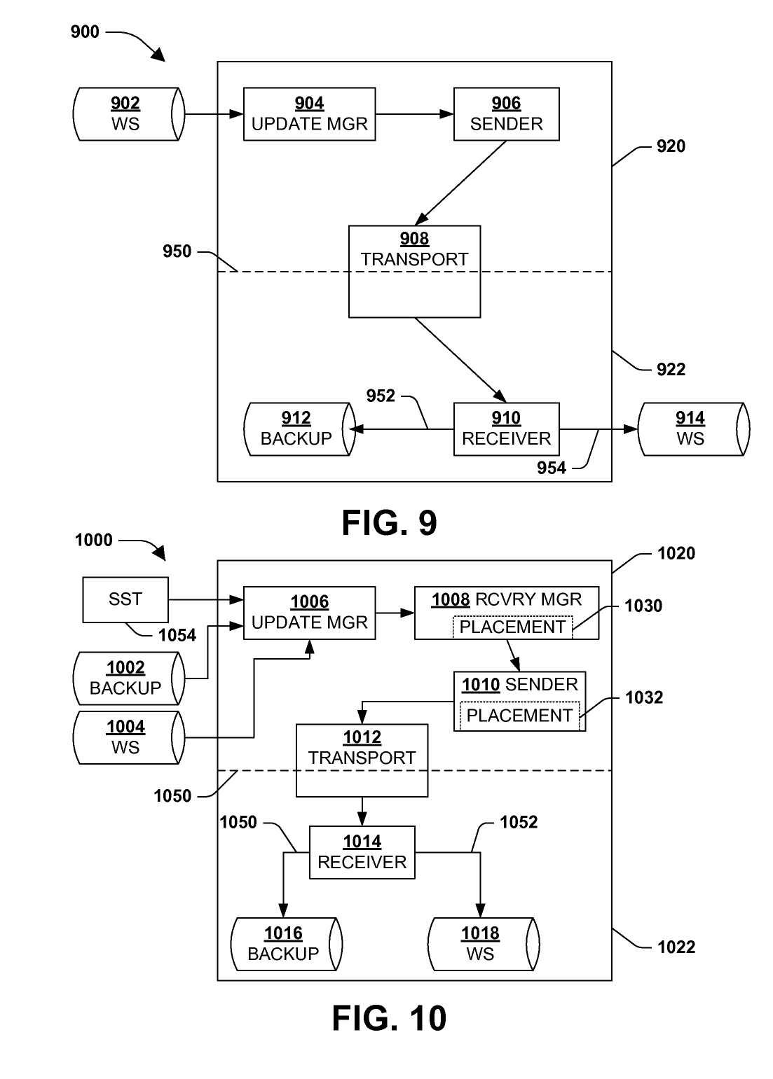

FIG. 9 is a component diagram illustrating one embodiment 900 of an implementation of one or more of the systems described herein. In this embodiment, the location determination component (e.g., 816 of FIG. 8) can be disposed in the sender component 906. In this embodiment 900, a notification is sent from the working storage 902 to the update manager 904, of a first server 920, that data has changed (e.g., new or changed key-value pair). The update manager 904 acquires a copy of the changed data, and sends it to the sender component 906.

The sender component 906 can determine a suitable location to keep the copy of the data as a backup copy (e.g., a backup location). In one embodiment, the sending component can perform a load balancing determination, for example, based on availability of the respective servers and how much data is already stored thereon. The sender block can then address the backup copy with the determined backup location server, including identifying it as going to the backup store, and forward it to the transport 908 connected with the first server 920.

The transport 908 sends the backup copy across the transport layer 950 to the backup location server 922 identified by the address. A receiver component in the backup location server retrieves the backup copy and forwards it to its backup storage 912. In another embodiment, if the copy of the key-value pair was intended for working storage (e.g., 914) on a second server (e.g., 922), the sender 906 may address the copy as such so that the receiver 910 forwards the copy to the working store 914.

In one embodiment, the key-value pairs stored in working storage (e.g., 808 of FIG. 8) and backup storage (e.g., 818 of FIG. 8), may comprise metadata. In this embodiment, the metadata can include primary location metadata that identifies the primary location server where the working store stores the key-value pair. Further, the metadata can include backup location metadata that identifies the backup location server where the backup store stores the backup copy. Additionally, the metadata can include version number metadata that identifies a version of the value in the key-value pair, where the version number is incremented for respective value changes in the key-value pair.

FIG. 10 is a component diagram illustrating one embodiment 1000 of an implementation of one or more of the systems described herein. In this embodiment 1000, a slave status tracker 1054 disseminates status reports (e.g., from a master status tracker) for the plurality of connected servers to the first server 1020, where status reports can include a notification of a server status of one or more of the plurality of servers. In one embodiment, server status can comprise: a server up; or a server down; or a server coming up; or a server coming down.

The update manager 1006 receives a notification that a server status has changed (e.g., going from up to coming down). A recovery manager 1008 receives a server status change notification and retrieves respective key-value pairs from the backup store 1002, when the server that comprises a primary location for the key-value pair is no longer able to act as the first primary location (e.g., down or coming down). In one embodiment, the recovery manager 1008 may comprise a recovery placement component 1030 that applies a placement algorithm to determine an appropriate location for the data, for example, based on load balancing.

The recovery manager 1008 forwards copies of key-value pairs (e.g., from a server coming down or down) to the sender component 1010, can comprise a location determination component 1032 (placement). The location determination component 1032 determines a second primary location 1022 for the key-value pairs. In this embodiment, the location determination component 1032 identifies the second primary location server 1022 by using the key from the backup copy of the key-value pair; and determines that the identified primary location server 1022 is in a condition to act as the second primary location.

The key-value copy is forwarded to the transport 1012, transported across the transport layer 1050 to the backup location server 1022. Here, if the key-value copy is addressed to go to the primary location 1052, the receiver 1014, forwards it to the working storage 1018 of the primary location server 1022.

In another embodiment, the recovery manager 1008 may notify the location determination component 1032, such as disposed in the sender component 1010, that the first server 1020 has a pending server coming down status (e.g., for maintenance). In this embodiment, the location determination component 1032 can determine an alternate (second) primary location for the respective working store key-value pairs in the working store 1004 of the first server 1020. Further, the location determination component 1032 can determine an alternate (second) backup location for the respective backup store key-value pairs in the backup store 1002 of the first server 1020.

In this embodiment, the sending component 1010 can send the respective working store key-value pairs to the respective alternate primary locations (e.g., 1022). Further, the sending component 1010 can send the respective backup store key-value keys to the respective second backup locations, such as the backup store 1016 on the second server 1022. Here, the receiver 1014 in the second backup storage location server 1022 can forward 1050 the copy to the backup store 1016.

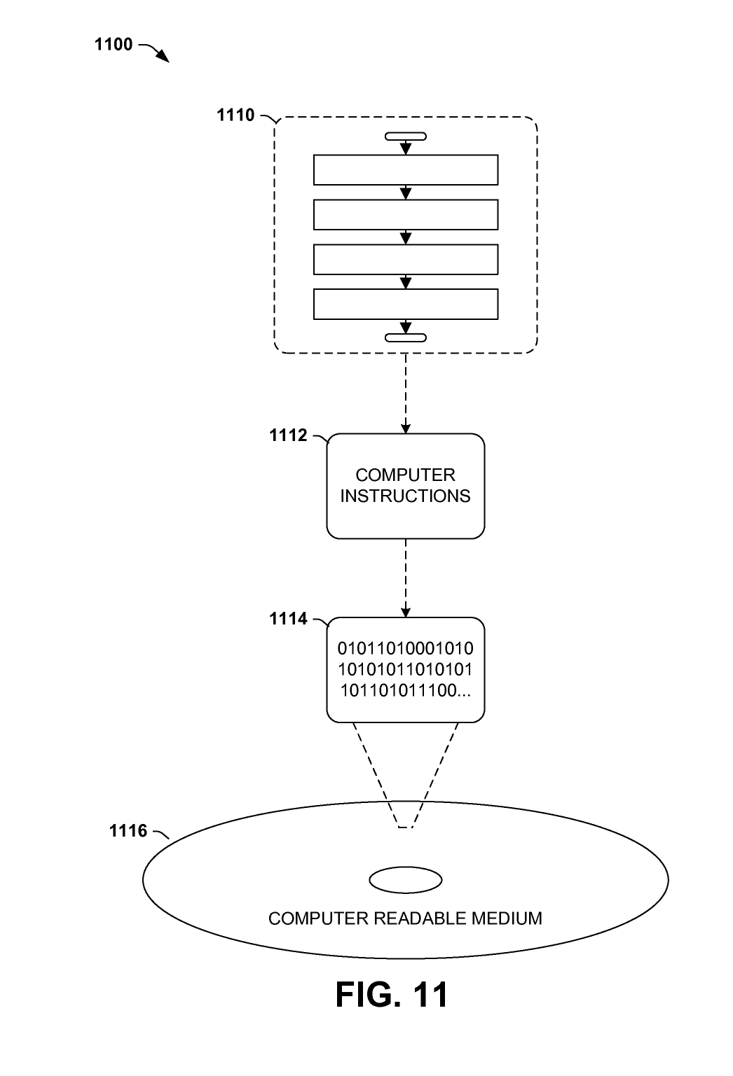

Still another embodiment involves a computer-readable medium comprising processor-executable instructions configured to implement one or more of the techniques presented herein. An exemplary computer-readable medium that may be devised in these ways is illustrated in FIG. 11, wherein the implementation 1100 comprises a computer-readable medium 1108 (e.g., a CD-R, DVD-R, or a platter of a hard disk drive), on which is encoded computer-readable data 1106. This computer-readable data 1106 in turn comprises a set of computer instructions 1104 configured to operate according to one or more of the principles set forth herein. In one such embodiment 1102, the processor-executable instructions 1104 may be configured to perform a method, such as the exemplary method 200 of FIG. 2, for example. In another such embodiment, the processor-executable instructions 1104 may be configured to implement a system, such as the exemplary system 800 of FIG. 8, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

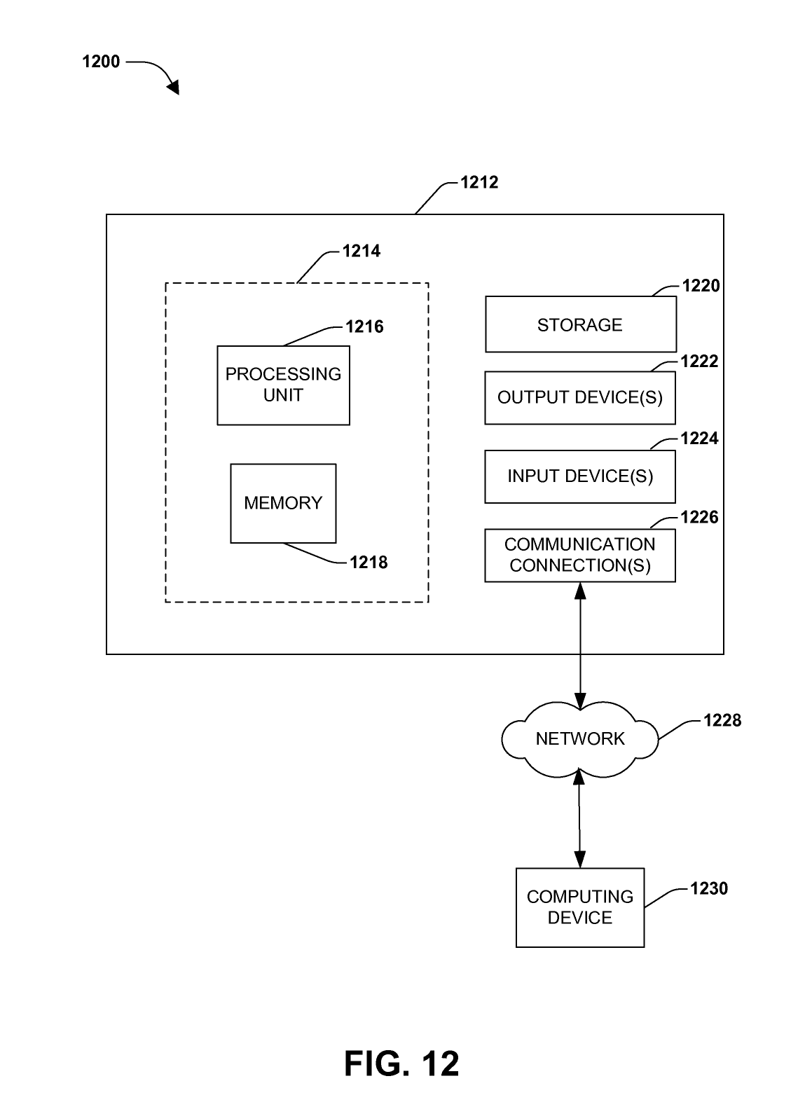

FIG. 12 and the following discussion provide a brief, general description of a suitable computing environment to implement embodiments of one or more of the provisions set forth herein. The operating environment of FIG. 12 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 12 illustrates an example of a system 1210 comprising a computing device 1212 configured to implement one or more embodiments provided herein. In one configuration, computing device 1212 includes at least one processing unit 1216 and memory 1218. Depending on the exact configuration and type of computing device, memory 1218 may be volatile (such as RAM, for example), non-volatile (such as ROM, flash memory, etc., for example) or some combination of the two. This configuration is illustrated in FIG. 12 by dashed line 1214.

In other embodiments, device 1212 may include additional features and/or functionality. For example, device 1212 may also include additional storage (e.g., removable and/or non-removable) including, but not limited to, magnetic storage, optical storage, and the like. Such additional storage is illustrated in FIG. 12 by storage 1220. In one embodiment, computer readable instructions to implement one or more embodiments provided herein may be in storage 1220. Storage 1220 may also store other computer readable instructions to implement an operating system, an application program, and the like. Computer readable instructions may be loaded in memory 1218 for execution by processing unit 1216, for example.

The term “computer readable media” as used herein includes computer storage media. Computer storage media includes volatile and nonvolatile, removable and non-removable media implemented in any method or technology for storage of information such as computer readable instructions or other data. Memory 1218 and storage 1220 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1212. Any such computer storage media may be part of device 1212.

Device 1212 may also include communication connection(s) 1226 that allows device 1212 to communicate with other devices. Communication connection(s) 1226 may include, but is not limited to, a modem, a Network Interface Card (NIC), an integrated network interface, a radio frequency transmitter/receiver, an infrared port, a USB connection, or other interfaces for connecting computing device 1212 to other computing devices. Communication connection(s) 1226 may include a wired connection or a wireless connection. Communication connection(s) 1226 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1212 may include input device(s) 1224 such as keyboard, mouse, pen, voice input device, touch input device, infrared cameras, video input devices, and/or any other input device. Output device(s) 1222 such as one or more displays, speakers, printers, and/or any other output device may also be included in device 1212. Input device(s) 1224 and output device(s) 1222 may be connected to device 1212 via a wired connection, wireless connection, or any combination thereof. In one embodiment, an input device or an output device from another computing device may be used as input device(s) 1224 or output device(s) 1222 for computing device 1212.

Components of computing device 1212 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1212 may be interconnected by a network. For example, memory 1218 may be comprised of multiple physical memory units located in different physical locations interconnected by a network.

Those skilled in the art will realize that storage devices utilized to store computer readable instructions may be distributed across a network. For example, a computing device 1230 accessible via network 1228 may store computer readable instructions to implement one or more embodiments provided herein. Computing device 1212 may access computing device 1230 and download a part or all of the computer readable instructions for execution. Alternatively, computing device 1212 may download pieces of the computer readable instructions, as needed, or some instructions may be executed at computing device 1212 and some at computing device 1230.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for backing up in-memory working store data, comprising:
a first server, from a plurality of connected servers, detecting a data change for a key-value pair in a distributed in-memory working store;
the first server determining a backup location for storing a backup copy of the key-value pair, the backup location comprised on a backup location server from the plurality of connected servers, the determining comprising:
using a key from the key-value pair to identify the backup location server; and
determining if the backup location server is available to store the backup copy; and
the first server sending the backup copy to the backup location server without prior permission from the backup location server and without subsequent feedback from the backup location server concerning the sending of the backup copy.

2. The method of claim 1, the first server determining a backup location comprising:
determining that a primary location for the key-value pair is the first server, determining the primary location comprising:
using the key to identify a primary location server; and
determining if the primary location server is available to store the key-value pair;
identifying the backup location server for the key-value pair using the key; and
determining that a status of the backup location sever is a condition that is able to store the backup copy.

3. The method of claim 2, comprising the first server sending the key-value pair to the primary location comprised on the primary location server, if the first server is not the primary location for the key-value pair.

4. The method of claim 1, comprising the first server:
identifying a status change of a server in the plurality of servers;
determining the primary location for a first server working store key-value pair, based on the key from the key-value pair and the status of a primary location server identified by the key; and
if the first server is not the primary location server:
updating primary location metadata associated with the first server working store key-value pair to identify the primary location server; and
sending the first server working store key-value pair to the primary location server.

5. The method of claim 4, comprising the first server:
determining the backup location for a copy of the first server backup store key-value pair, based on the key from the key-value pair and the status of the backup location server identified by the key;
sending the copy of the first server backup store key-value pair to the backup location server identified by backup location metadata associated with the first server backup store key-value pair, if the backup location metadata associated with the first server backup store key-value pair does not correspond to the backup location.

6. The method of claim 4, comprising the first server scheduling removal of the first server working store key-value pair from its working store if:
the primary location metadata associated with the first server working store key-value pair does not identify the first server;
the status of the first server is in an up condition; and
the status of the primary location server is a condition to act as a primary location for the key-value pair.

7. The method of claim 4, identifying a status change of a server in the plurality of servers, comprising receiving a status report for the plurality of servers indicating one or more server status changes.

8. The method of claim 4, where the first server is not the primary location server, comprising the primary location server:
receiving the key-value pair from the first server, comprising a data change in its working store;
determining a backup location for storing a backup copy of the key-value pair, the backup location comprised on a backup location server from the plurality of connected servers; and
sending the backup copy to the backup location server.

9. The method of claim 1, comprising the key-value pair comprising metadata, the metadata comprising one or more of:
backup location metadata that identifies the backup location server that comprises the backup store location for the backup copy;
primary location metadata that identifies the primary location server that comprises the working store location for the key-value pair; and
version number metadata that identifies a version of the value in the key-value pair, where the version number is incremented for respective value changes in the key-value pair.

10. The method of claim 9, determining a backup location for storing a backup copy of the key-value pair comprising using the backup location metadata to identify the backup location.

11. The method of claim 1, when the first server has prior knowledge of an impending status comprising a condition in which the first server is unable to act as a primary location, comprising:
the first server sending one or more copies of key-value pairs from its working store to one or more second primary location servers based on respective keys from the key value pairs and a determination of an availability of the one or more the second primary location servers; and
the first server sending one or more backup copies of key-value pairs from its backup store to one or more second backup location servers based on respective keys from the backup copies of the key value pairs and a determination of an availability of the one or more the second backup location servers.

12. The method of claim 1, comprising using a load balancing determination to select a primary location server or backup location server based on a status of the plurality of servers.

13. A system for backing up in-memory working store data, comprising:
a plurality of servers, operably coupled over a transport layer, respectively comprising an in-memory working store configured to store a working store key-value pair for respective data stored in the working store;
a first server of the plurality of servers comprising:
a backup store configured to store a backup store key-value pair, the backup store key-value pair comprising a backup copy of a working store key-value pair from a primary location server;
an update manager configured to receive a notification that data has changed for a key-value pair in the working store;
a location determination component operably coupled with the update manager, and configured to determine a backup location for storing a backup copy of the working store key-value pair, comprising:
identifying a backup location server from the plurality of servers that comprises the backup location by using the key from the working store key-value pair; and
determining that the identified backup location server is in a condition to act as the backup location; and
a sender component operably coupled with the location determination component, and configured to send the backup copy to the transport layer to be sent to the backup location server without prior permission from the backup location server and without subsequent feedback from the backup location server concerning the sending of the backup copy; and
the transport layer operably coupled to the respective servers and configured to forward the backup copy from the first server to the backup location server.

14. The system of claim 13, the data change comprising one of:
a creation of a key-value pair;
an alteration of the value in the key-value pair; and
a deletion of the key-value pair.

15. The system of claim 13, the key-value pair comprising metadata, the metadata comprising one or more of:
backup location metadata that identifies the backup location server that comprises the backup store location for the backup copy;
primary location metadata that identifies the primary location server that comprises the working store location for the key-value pair; and
version number metadata that identifies a version of the value in the key-value pair, where the version number is incremented for respective value changes in the key-value pair.

16. The system of claim 13, comprising a slave status tracker configured to disseminate status reports for the plurality of connected servers to the first server, where status reports comprise a notification of a server status of one or more of the plurality of servers, where a server status comprises one of:
a server up;
a server down;
a server coming up; and
a server coming down.

17. The system of claim 16, comprising a recovery manager operably coupled with the slave status tracker, and configured to:
receive server status change notifications from the slave status tracker;
retrieve key-value pairs from the backup store that comprise backup copies of the primary location key-value pairs, when the first primary location server is unable to act as the primary location; and
forward the backup copies of the key-value pairs to the location determination component, the location determination component configured to determine a second primary location for the key-value pairs, comprising, for the respective pairs:
identify a second primary location server from the plurality of servers by using the key from the backup copy of the key-value pair; and
determine that the identified primary location server is in a condition to act as the primary location.

18. The system of claim 16, comprising:
the recovery manager configured to notify the location determination component that the first server has a pending server coming down status;
the location determination component configured to:
determine a second primary location for the respective working store key-value pairs in the working store of the first server; and
determine a second backup location for the respective backup store key-value pairs in the backup store of the first server;
the sending component configured to:
send the respective working store key-value pairs to the respective second primary locations; and
send the respective backup store key-value keys to the respective second backup locations.

19. The system of claim 13, the location determination component comprising:
a backup location determination component configured to determine a backup location server by applying a function to the key from a key-value pair;
a primary location determination component configured to determine a primary location server by applying a function to the key from a key-value pair; and
a server status identification component configured to:
determine if the status of the server identified by the backup location determination component meets a desired status to act as a backup location server;
notify the server status identification component to determine a second backup location if the status does not meet the desired status;
determine if the status of the server identified by the primary location determination component meets a desired status to act as a primary location server; and
notify the server status identification component to determine a second primary location if the status does not meet the desired status.

20. A method for backing up in-memory working store data, comprising:
a first server, connected with a plurality of servers, detecting a state change in a distributed in-memory working store;
if the state change is a change of data associated with a key-value pair, the change of data comprising one of: creation of the key-value pair, and alteration of a value in the key-value pair:
where the first server is a primary location for the key-value pair:
the first server determining a second server from the plurality of servers for storing a backup copy of the key-value pair, the second server is identified by one or more of:
backup server identification metadata associated with the data key-value pair; and
a data storage load balancing determination for the plurality of servers; and
the first server sending the backup copy to the second server without prior permission from the second server and without subsequent feedback from the second server concerning the sending of the backup copy; and
the first server sending key-value pair to a third server identified by primary server identification metadata associated with the key-value pair without prior permission from the third server and without subsequent feedback from the third server concerning the sending of the key-value pair; and
if the state change is a change of server status of one of the plurality of servers:
the first server determining a primary location and a backup location for a key-value pair in its portion of the distributed working store based on the key in the key-value pair and a status of the server associated with the key;
if the primary location is not the first server and the primary location is not identified by server identification metadata associated with the key-value pair, the first server:
updating the server identification metadata associated with the key-value pair to identify the primary location; and
sending the key-value pair to a server associated with the primary location;
if the backup location is not identified by backup server identification metadata associated with the data key-value pair, the first server sending a backup copy of the key-value pair to a server identified by the backup server identification metadata associated with the data key-value pair; and
if the server identification metadata associated with the key-value pair does not identify the first server, and a first server status condition is up, and the server status condition of the server identified by the server identification metadata associated with the key-value pair is up, the first server removing the key-value pair from its portion of the distributed working store.
